(19) United States
(12) Patent Application Publication
(10) Pub. No.: US 2025/0072471 A1
(43) Pub. Date: Mar. 6, 2025

(54) METHOD FOR PREPARING ADDITIVE LIQUID OF ATOMIZER, ADDITIVE LIQUID, AND ATOMIZER

(71) Applicant: SMOORE INTERNATIONAL HOLDINGS LIMITED, George Town (KY)

(72) Inventors: Zhenxing DU, Shenzhen (CN); Xiaoxiang LIAO, Shenzhen (CN)

(21) Appl. No.: 18/772,822

(22) Filed: Jul. 15, 2024

(30) Foreign Application Priority Data
Aug. 30, 2023 (CN) 202311107627.2

(51) Int. Cl. A24B 15/167; A24B 15/18; A24B 15/22; A24F 40/10; B01D 15/36; B01D 61/42

(52) U.S. Cl. CPC A24B 15/167; A24B 15/18; A24B 15/22; A24F 40/10; B01D 15/362; B01D 15/363; B01D 61/422; B01D 2311/02

(57) ABSTRACT

A method for preparing an additive liquid of an atomizer includes: removing cations. In an embodiment, the method further comprises: removing anions to obtain a liquid with an electrical conductivity less than 1000 μS/cm. In an embodiment, the cations are selected from a group including: manganese ions, iron ions, zinc ions, copper ions, potassium ions, magnesium ions, calcium ions, and sodium ions.

### CROSS-REFERENCE TO PRIOR APPLICATION

Priority is claimed to Chinese Patent Application No. 202311107627.2, filed on Aug. 30, 2023, the entire disclosure of which is hereby incorporated by reference herein.

### FIELD

The present invention relates to the field of electronic atomization technologies, and in particular, to a method for preparing an additive liquid of an atomizer, an additive liquid, and an atomizer.

### BACKGROUND

With the landing of the new national standards, tobacco-flavored electronic atomization devices have become the mainstream in China. However, due to the presence of tobacco extracts in an atomization liquid, problems such as burnt coil and gunk buildup of such products frequently emerge. In addition, there is a problem of poor atomization performance of the atomization liquid, making it difficult to implement inhaling experience of a large vapor amount and a large quantity of puffs (for example, greater than 1000 puffs).

To resolve these problems, current research mainly focuses on removing large molecules (such as polysaccharides, proteins, starch, and pectin) from tobacco or tobacco extracts by using some technologies. This causes removal of fragrance components along with the large molecules, resulting in excessive fragrance loss. In addition, in these methods, the problems such as burnt coil and gunk buildup are not completely resolved, and long-term inhaling experience of a large vapor quantity and a large quantity of puffs cannot be implemented.

Therefore, there is a strong need to preserve fragrance and resolve the problems such as burnt coil and gunk buildup.

### SUMMARY

In an embodiment, the present invention provides a method for preparing an additive liquid of an atomizer, comprising: removing cations.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is an XLY atomization liquid before processing and a fouling diagram of the XLY atomization liquid after processing in an electronic atomization device according to Embodiment 1 and Embodiment 9;

FIG. 2 is a ZBY atomization liquid before processing and a fouling diagram of the ZBY atomization liquid after processing in an electronic atomization device according to Embodiment 2 and Embodiment 12;

FIG. 3 is a DFY atomization liquid before processing and a fouling diagram of the DFY atomization liquid after processing in an electronic atomization device according to Embodiment 3; and

FIG. 4 is an NB2 atomization liquid before processing and a fouling diagram of the NB2 atomization liquid after processing in an electronic atomization device according to Embodiment 4.

### DETAILED DESCRIPTION

In an embodiment, the present invention provides a method for preparing an additive liquid of an atomizer.

In some implementations, the method of the present invention includes a step of removing cations.

In a process of preparing the additive liquid of the atomizer, a step of removing cations is introduced, thereby reducing a vapor attenuation rate, and improving inhaling experience. In addition, a fouling amount is reduced, and problems such as burnt coil and gunk buildup of the atomizer are resolved.

In some implementations, the method of the present invention further includes a step of removing anions to obtain a liquid with an electrical conductivity less than 1000 μS/cm, preferably less than 500 μS/cm.

On the basis of removing cations, in a further process of preparing the additive liquid of the atomizer, the step of removing anions is introduced, so that not only a vapor attenuation rate is further reduced, but also an atomization amount is additionally increased, and a fouling amount is further reduced, thereby further optimizing inhaling experience, and reducing a probability of causing burnt coil and gunk buildup.

In some implementations, the cations are selected from one or more of manganese ions, iron ions, zinc ions, copper ions, potassium ions, magnesium ions, calcium ions, and sodium ions.

In some implementations, the step of removing cations is performed by using a cation exchange resin. In some implementations, the step of removing anions is performed by using an anion exchange resin.

In some implementations, the step of removing cations and the step of removing anions are implemented through electrodialysis.

When electrodialysis processing is introduced in the process of preparing the additive liquid of the atomizer, compared with an ion exchange method, in some implementations of the present invention, an atomization amount is further increased, and a vapor attenuation rate is further reduced, thereby providing excellent atomization performance, and improving inhaling experience. In addition, a fouling amount is further reduced, and further, a probability of causing burnt coil and gunk buildup is further reduced. The inventors do not want to be bound by theory because the electrodialysis method not only removes cations and anions, but also removes organic acids and organic bases from the liquid. In addition, compared with an ion exchange method, an operation step of the electrodialysis method is more simplified, and processing efficiency is greatly improved. The electrodialysis method can maintain the mouthfeel of the atomization liquid.

In some implementations, a voltage during the electrodialysis is set to 1 V to 30 V; a current during the electrodialysis is set to 0.05 A to 20 A; and duration of the electrodialysis is 0.1 hour to 24 hours.

In a preferred implementation, the voltage during the electrodialysis is set to 12 V to 16 V, and the current during the electrodialysis is set to 5 A to 10 A; and duration of the electrodialysis is 1 hour to 4 hours.

The foregoing parameters are selected, so that use of the electrodialysis method further increases an atomization amount and reduces a vapor attenuation rate, thereby providing better inhaling experience.

In some implementations, before or after the removal step, the method further includes a step of adding an atomization solvent and/or an essence.

In some implementations, before the removal step, the method further includes a step of diluting a to-be-processed substance with water to obtain a diluted liquid with a viscosity of 1 cp to 100 cp, and after the removal step, the method further includes a step of removing water. In the present invention, a dilution multiple is not limited, provided that the removal step can be performed after the dilution. For example, in some implementations, dilution is performed by adding water with a volume greater than or equal to 0 times and less than or equal to 20 times a volume of the to-be-processed substance. In a preferred implementation, the volume of the to-be-processed substance is greater than 0 times and is less than or equal to 10 times of water for dilution. In this dilution, not only a liquid viscosity is moderate, but also cations and/or anions are removed. That a large quantity of water needs to be removed in the step of removing water is avoided, thereby shortening duration of removing water and improving efficiency of removing water.

A second aspect of the present invention provides an additive liquid of an atomizer prepared by using the method of the present invention.

A third aspect of the present invention provides an atomizer, including a liquid storage chamber, an atomization component, and the additive liquid of the present invention. The liquid storage chamber is configured to accommodate an additive liquid of the atomizer. The atomization component is configured to form an aerosol from the additive liquid of the atomizer. The atomization component is in fluid communication with the liquid storage chamber.

The following clearly and completely describes the technical solutions in the implementations of the present disclosure with reference to the implementations of the present disclosure. Clearly, the described implementations are only a part of the implementations of the present disclosure, not all the implementations. All other implementations obtained by a person of ordinary skill in the art based on the implementations of the present disclosure without creative efforts shall fall within the protection scope of the present disclosure.

In the entire specification, unless otherwise noted, the terms used herein shall be understood to mean what is normally used in the art. Therefore, unless otherwise defined, all technical and scientific terms used herein have the same meaning as those of ordinary skill in the art. The meaning in this specification is preferred if there is any contradiction.

It should be noted that, in the present disclosure, the term “include” or any other variant thereof is intended to cover non-exclusive inclusions, so that a method or apparatus that includes a series of elements includes not only explicitly recorded elements, but also other elements that are not explicitly listed, or elements that are inherent to the implementation of the method or apparatus. In the case in which there is no further limitation, an element defined by a statement “containing . . . ” does not exclude that another related element exists in a method or an apparatus including the element.

Currently, an electronic atomization device with a tobacco taste becomes the mainstream, and an atomization liquid added to the atomization apparatus includes a tobacco extract. This causes problems of burnt coil and gunk buildup of such a product, causes a decrease in atomization performance (for example, a large vapor quantity and a large quantity of puffs), and then seriously affects inhaling experience.

To solve such problems, some researchers use solvent extraction, column chromatography, enzymolysis approach, supercritical extraction, and molecular distillation to reduce the content of macromolecules. However, these methods remove fragrance components (e.g., esters and ketones) while removing macromolecules, resulting in excessive fragrance loss. In addition, in these methods, the problems such as burnt coil and gunk buildup are not well resolved, and long-term inhaling experience of a large vapor quantity and a large quantity of puffs cannot be implemented.

Both burnt coil and gunk buildup are caused by excessive fouling of an atomized aerosol in the atomizer. The inventors of the present invention unexpectedly find that cations in an additive liquid of the atomizer play a relatively important role in fouling generation.

To this end, the present invention provides a method for preparing an additive liquid of an atomizer. The method includes a step of removing cations from a liquid. This method not only preserves fragrance components, but also resolves problems of burnt coil and gunk buildup.

As used herein, “additive liquid of the atomizer” and “additive liquid” refer to a liquid used to be added to the electronic atomizer, so as to be able to provide a user with a sense of experience of blowing a cloud. The additive liquid of the atomizer may be in the form of oil or liquid. The additive liquid of the atomizer is prepared, for example, from a tobacco extract. An exemplary additive liquid may contain nicotine, an essence, an atomization solvent, and the like.

In the method of the present invention, a to-be-processed substance for which a removal step is performed may be a raw material used as the atomization liquid of the atomizer, that is, the tobacco extract, and the tobacco extract includes a component that provides inhaling experience for the user. For example, the tobacco extract may be in the form of liquid, paste, or solid, such as a lyophilized substance. The to-be-processed substance may alternatively be a product further added with another component (such as an essence or an atomization solvent) or further processed on the basis of a tobacco extract. For example, the to-be-processed substance may alternatively be an instantly available atomization liquid (which can be added to the atomizer for use) prepared from a tobacco extract, such as a commercially available atomization liquid.

In fact, currently, many studies in the art believe that the foregoing biological macromolecules in the additive liquid of the atomizer are the main cause of fouling of the atomizer, and that the ion exchange method is used to remove ions in the additive liquid of the atomizer to reduce fouling, burnt coil, and/or gunk buildup of the atomizer is not reported.

In some implementations, the method of the present invention does not include a step of removing macromolecules (such as polysaccharides, proteins, starch, and/or pectin).

In some implementations, the step of removing cations is performed by using a cation exchange resin. In the present invention, the type of the cation removed by the ion exchange method is not limited, and is determined by a to-be-processed object. In some implementations, the cations of the present invention refer to inorganic cations. For example, when a commercially available atomization liquid is processed, the removed cations may be one or more of manganese ions, iron ions, zinc ions, copper ions, potassium ions, magnesium ions, calcium ions, sodium ions, and the like. The present invention imposes no limitation on the type of a cation exchange resin, provided that cations in a liquid phase can be exchanged. For example, the cation exchange resin may be a cation exchange resin T-42 h. The mass ratio of the to-be-processed liquid to the cation exchange resin is not specifically limited in the present invention, and an exemplary mass ratio is less than or equal to 10/1, for example, 10/1, 4/1, and ½.

In some implementations, the method of the present invention further includes a step of removing anions from the liquid. In some implementations, the step of removing anions is performed by using an anion exchange resin. In some implementations, the anions of the present invention refer to inorganic anions. In the present invention, a type of the anion removed by the ion exchange method is not limited, and is determined by a to-be-processed object. For example, when a commercially available atomization liquid is processed, the removed anions may be one or more of fluorine ions, chloride ions, nitrite ions, bromine ions, nitrate ions, sulfate ions, phosphate ions, and the like. The present invention imposes no limitation on the type of an anion exchange resin, provided that anions in a liquid phase can be exchanged. For example, the model of the anion exchange resin may be D201. The mass ratio of the to-be-processed liquid to the anion exchange resin is not specifically limited in the present invention, and an exemplary mass ratio is less than or equal to 10/1, for example, 10/1, 4/1, and ½.

In some implementations, the step of removing cations may be performed before the step of removing anions. For example, the step of removing cations includes: adding a cation exchange resin whose mass is 1/10 to 2/1 of the liquid, stirring, and filtering to obtain supernatant. Next, the step of removing anions include: taking the above supernatant; and adding an anionic exchange resin whose mass is 1/10 to 2/1 of the obtained supernatant, stirring, and filtering. For example, stirring and filtering may be performed at a rotation speed of 120 rpm for 4 h at the normal temperature.

In some other implementations, the step of removing cations may be performed after the step of removing anions.

Processing duration when an ion exchange resin is used is not particularly limited in the present invention, provided that most corresponding ions can be removed.

In some implementations, when the to-be-processed object is a raw material of an atomization liquid, for example, a tobacco extract, after cations and/or anions are removed, the products of the removal steps may be compounded with a substance such as an atomization solvent and/or an essence to prepare an additive liquid.

In some other implementations, the method for preparing an additive liquid of an atomizer according to the present invention includes:

obtaining a tobacco extract; and

using electrodialysis processing to obtain a liquid with an electrical conductivity of less than or equal to 1000 μS/cm.

In the present invention, a device used for electrodialysis is not limited. For example, the device used for electrodialysis may be a CR-DTM homogeneous membrane electrodialysis apparatus.

For example, the electrical conductivity of the liquid processed by the method in the present invention may be less than or equal to 800 μS/cm, less than or equal to 600 μS/cm, less than or equal to 500 μS/cm, less than or equal to 400 μS/cm, less than or equal to 300 μS/cm, less than or equal to 200 μS/cm, less than or equal to 100 μS/cm, less than or equal to 50 μS/cm, less than or equal to 40 μS/cm, and less than or equal to 30 μS/cm.

In the method of the present invention, a voltage when electrodialysis is used may be, for example, 1 V to 30 V, for example, 2 V, 3 V, 4 V, 5 V, 6 V, 7 V, 8 V, 9 V, 10 V, 11 V, 12 V, 13 V, 14 V, 15 V, 16 V, 17 V, 18 V, 19 V, 20 V, 21 V, 22 V, 23 V, 24 V, 25 V, 26 V, 27 V, 28 V, 29 V, and 30 V.

In the method of the present invention, a current when electrodialysis is used may be, for example, 0.05 A to 20 A, for example, 0.05 A, 0.1 A, 0.5 A, 1 A, 2 A, 3 A, 4 A, 5 A, 6 A, 7 A, 8 A, 9 A, 10 A, 11 A, 12 A, 13 A, 14 A, 15 A, 16 A, 17 A, 18 A, 19 A, and 20 A.

In the method of the present invention, duration when electrodialysis is used may be, for example, greater than 0.1 hours, for example, greater than 0.2 hours, greater than 0.5 hours, greater than 1 hour, greater than 2 hours, greater than 3 hours, greater than 4 hours, greater than 6 hours, greater than 8 hours, greater than 10 hours, greater than 12 hours, and greater than 24 hours.

In some implementations, the method of the present invention further includes a step of compounding the tobacco extract with a substance such as an atomization solvent and/or an essence. For example, the step of compounding is performed before electrodialysis.

In some implementations, optionally, before the step of removing cations or before electrodialysis, the method of the present invention further includes a step of diluting the liquid with water, where the viscosity of the diluted liquid is 1 cp to 100 cp. Dilution reduces the viscosity of the liquid, facilitating the addition of a cation exchange resin (optionally, and an anion exchange resin). Alternatively, liquid fluidity is increased, so as to facilitate the electrodialysis circulation. Dilution with water can give or enhance a medium environment to which ions can migrate. For example, in some implementations, the volume of the additive liquid is greater than 0.1 times and less than or equal to 20 times of the water for dilution. In a preferred implementation, the volume of the to-be-processed substance is greater than 0 times and is less than or equal to 10 times of water for dilution. In this dilution, not only a liquid viscosity is moderate, but also cations and/or anions are removed. That a large quantity of water needs to be removed in the step of removing water is avoided, thereby shortening duration of removing water and improving efficiency of removing water. In a specific implementation, deionized water is used for dilution. Deionized water can be used to dilute without introducing a large amount of ions.

In some implementations, after the step of removing cations or after electrodialysis, the method of the present invention further includes a step of removing moisture. In some preferred implementations, the step of removing moisture is after the step of removing anions or after electrodialysis. Removing moisture can increase the concentration of the additive liquid, so as to avoid affecting the inhaling experience when the additive liquid is used to prepare the atomization liquid or when the additive liquid is used as the atomization liquid. For example, moisture may be removed by rotary evaporation or freeze drying.

The present invention further provides an additive liquid of an atomizer, and the additive liquid is prepared by using the method of the present invention. Such an additive liquid removes at least most inorganic cations, such as 50%, 60%, 70%, 80%, 90%, 95%, 96%, 97%, 99% inorganic cations are removed. Preferably, most inorganic anions are also removed, such as 50%, 60%, 70%, 80%, 90%, 95%, 96%, 97%, 99% inorganic anions are removed. More preferably, most organic acids and organic bases are also removed, for example, 50%, 60%, 70%, 80%, 90%, 95%, 96%, 97%, 99% organic acids and organic bases are removed. Not only fragrance components are preserved, but also problems of burnt coil and gunk buildup are resolved.

The present invention further provides an atomizer, including a liquid storage chamber, an atomization component, and the additive liquid of the present invention. The liquid storage chamber is configured to accommodate the additive liquid. The atomization component is in fluid communication with the liquid storage chamber and is configured to form an aerosol from the additive liquid.

The present invention further provides an atomization apparatus, including the foregoing atomizer and a battery component. The battery component is configured to supply power to the atomizer.

The present invention further provides an additive liquid of an atomizer for use of improving fouling, burnt coil, and/or gunk buildup of the atomizer.

The following further describes the present invention in detail with reference to specific embodiments. The objective thereof is merely illustrative and is not intended to limit the scope of the present disclosure. In the following embodiments, an XLY atomization liquid, a ZBY atomization liquid, a DFY atomization liquid, and an NB2 atomization liquid are used, each containing 10 wt %-20 wt % of tobacco extract, 10 wt %-20 wt % of essence, and 60 wt %-80 wt % of atomization solvent. A tobacco extract (BL) is also used.

### Embodiment 1

Add the XLY atomization liquid to a beaker, add a cation exchange resin T-42 h with a mass of ¼ of the mass of a material liquid, stir at the normal temperature at 120 rpm for 4 h, and filter to obtain supernatant.

Take a proper amount of the supernatant, add an anion exchange resin D201 with a mass of ¼ of the mass of the material liquid, stir at the normal temperature at 120 rpm for 4h, filter, and obtain an atomization liquid A.

### Embodiment 2

Preprocessing of the atomization liquid:

Take a proper amount of ZBY atomization liquid, add water with a volume 10 times the volume thereof to dilute, and provide a medium environment for electric field migration.

Cation and anion removal:

Place the diluted atomization liquid in an electrodialysis apparatus, start the solution circulation process, set a voltage 14 V and a current value 7.5 A, start the electric field, stop the device after 3 hours of circulation, and take out the processed atomization liquid.

### Moisture Removal

Remove the moisture by means of rotary evaporation, and obtain an atomization liquid B.

### Embodiment 3

### Preprocessing of the Atomization Liquid

Take a proper amount of DFY atomization liquid, add water with a volume 10 times the volume thereof to dilute, and provide a medium environment for electric field migration.

### Cation and Anion Removal

Place the diluted atomization liquid in an electrodialysis apparatus, start the solution circulation process, set a voltage 14 V and a current value 7.5 A, start the electric field, stop the device after 3 hours of circulation, and take out the processed atomization liquid.

### Moisture Removal

Remove the moisture by means of rotary evaporation, and obtain an atomization liquid C.

### Embodiment 4

### Preprocessing of the Atomization Liquid

Take a proper amount of NB2 atomization liquid, add water with a volume 10 times the volume thereof to dilute, and provide a medium environment for electric field migration.

### Cation and Anion Removal

Place the diluted atomization liquid in an electrodialysis apparatus, start the solution circulation process, set a voltage 14 V and a current value 7.5 A, start the electric field, stop the device after 3 hours of circulation, and take out the processed atomization liquid.

### Moisture Removal

Remove the moisture by means of rotary evaporation, and obtain an atomization liquid D.

### Embodiment 5

### Preprocessing of the Atomization Liquid

Take a proper amount of ZBY atomization liquid, add water with a volume 10 times the volume thereof to dilute, and provide a medium environment for electric field migration.

### Cation and Anion Removal

Place the diluted atomization liquid in an electrodialysis apparatus, start the solution circulation process, set a voltage 30 V and a current value 20 A, start the electric field, stop the device after 10 min of circulation, and take out the processed atomization liquid.

### Moisture Removal

Remove the moisture by means of rotary evaporation, and obtain an atomization liquid E.

### Embodiment 6

### Preprocessing of the Atomization Liquid

Take a proper amount of ZBY atomization liquid, add water with a volume 10 times the volume thereof to dilute, and provide a medium environment for electric field migration.

### Cation and Anion Removal

Place the diluted atomization liquid in an electrodialysis apparatus, start the solution circulation process, set a voltage 1 V and a current value 0.05 A, start the electric field, stop the device after 10 h of circulation, and take out the processed atomization liquid.

### Moisture Removal

Remove the moisture by means of rotary evaporation, and obtain an atomization liquid F.

### Embodiment 7

### Preprocessing of the Atomization Liquid

Take a proper amount of ZBY atomization liquid, add water with a volume 0.5 times the volume thereof to dilute, and provide a medium environment for electric field migration.

### Cation and Anion Removal

Place the diluted atomization liquid in an electrodialysis apparatus, start the solution circulation process, set a voltage 14 V and a current value 7.5 A, start the electric field, stop the device after 3 hours of circulation, and take out the processed atomization liquid.

### Moisture Removal

Remove the moisture by means of rotary evaporation, and obtain an atomization liquid G.

### Embodiment 8

### Preprocessing of the Tobacco Extract

Take a proper amount of tobacco extract BL, add water with a volume 10 times the volume thereof to dilute, and provide a medium environment for electric field migration.

### Cation and Anion Removal

Place the diluted atomization liquid in an electrodialysis apparatus, start the solution circulation process, set a voltage 14 V and a current value 7.5 A, start the electric field, stop the device after 3 hours of circulation, and take out the processed atomization liquid.

### Moisture Removal

Remove the moisture by means of rotary evaporation, and obtain a liquid h. Preparation of the atomization liquid:

Mix the liquid h with the essence and the atomization solvent at a weight ratio of 1:15:84, heat, blend, and obtain an atomization liquid H.

### Embodiment 9

Add the XLY atomization liquid to a beaker, add a cation exchange resin T-42 h with a mass of ¼ of the mass of a material liquid, stir at the normal temperature at 120 rpm for 4 h, and filter to obtain an atomization liquid I.

### Embodiment 10

Add the XLY atomization liquid to a beaker, add a cation exchange resin T-42 h with a mass of 2 times of the mass of a material liquid, stir at the normal temperature at 120 rpm for 4 h, and filter to obtain supernatant.

Take a proper amount of the supernatant, add an anion exchange resin D201 with a mass of 2 time of the mass of the material liquid, stir at the normal temperature at 120 rpm for 4 h, filter, and obtain an atomization liquid J.

### Embodiment 11

Add the XLY atomization liquid to a beaker, add a cation exchange resin T-42 h with a mass of 1/10 of the mass of a material liquid, stir at the normal temperature at 120 rpm for 4 h, and filter to obtain supernatant.

Take a proper amount of the supernatant, add an anion exchange resin D201 with a mass of 1/10 of the mass of the material liquid, stir at the normal temperature at 120 rpm for 4 h, filter, and obtain an atomization liquid K.

### Embodiment 12

Add the ZBY atomization liquid to a beaker, add a cation exchange resin T-42 h with a mass of ¼ of the mass of a material liquid, stir at the normal temperature at 120 rpm for 4 h, and filter to obtain supernatant.

Take a proper amount of the supernatant, add an anion exchange resin D201 with a mass of ¼ of the mass of the material liquid, stir at the normal temperature at 120 rpm for 4 h, filter, and obtain an atomization liquid L.

### Test Example 1

### Electrical Conductivity Test

An electrical conductivity tester is used to measure the electrical conductivity of the atomization liquid and the liquid obtained in Embodiments 1 to 12. Results are shown in Table 1 below.

TABLE 1
Electrical conductivity of the atomization liquid
and the liquid obtained in Embodiments 1 to 12

| | Atomization liquid | | | | | | | | | | | |
|---|---|---|---|---|---|---|---|---|---|---|---|---|
| | A | B | C | D | E | F | G | H | I | J | K | L |
| Electrical | 105 | 26 | 32 | 30 | 55 | 460 | 108 | 43 | 161 | 93 | 214 | 96 |
| conductivity (μs/cm) | | | | | | | | | | | | |

### Test Example 2

### Test of Concentration Of Ions, Organic Acids, and Organic Bases

The component changes in the atomization liquid or the tobacco extract before and after the processing in Embodiments 1 to 12 are tested by using inductively coupled plasma emission spectroscopy (ICP), and the results are shown in Tables 2-24.

TABLE 2
Ion concentration in the XLY atomization liquid before processing and in
the XLY atomization liquid after processing according to Embodiment 1
Concentration of inorganic cations in the XLY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 1.12 | 3.24 | 3.43 | ND | 13546 | 346 | 634 | ND |
| processing | | | | | | | | |
| After | 0.06 | 0.118 | 0.233 | ND | 169.3 | 36.6 | 132 | ND |
| processing | | | | | | | | |

| Concentration of inorganic anions in the XLY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F | ion Cl⁻ | ion NO²⁻ | ion Br | ion NO³⁻ | ion SO₄²⁻ | ion PO₄³⁻ |
| Before | 55.6 | 5757.5 | ND | ND | 7278.2 | ND | ND |
| processing | | | | | | | |
| After | 12.7 | 321.7 | ND | ND | 163.4 | ND | ND |
| processing | | | | | | | |

Nd indicates that a corresponding ion concentration does not reach the lower limit for instrument detection, which is the same below.

It can be learned from Table 2 that the inorganic ion concentration in the XLY atomization liquid after ion exchange processing decreases substantially.

TABLE 3
Cation concentration in the atomization liquid before processing and in
the atomization liquid after processing according to Embodiments 2 to 4

| | Concentration of inorganic cations in the atomization liquid (mg/kg) | | | | | | | |
|---|---|---|---|---|---|---|---|---|
| | Ion type | | | | | | | |
| | Manganese/ | Iron/ | Zinc/ | Copper/ | Potassium/ | Magnesium/ | Calcium/ | Sodium/ |
| | Mn | Fe | Zn | Cu | K | Mg | Ca | Na |
| ZBY atomization | 2.31 | 2.32 | 4.24 | 0.123 | 3971.45 | 151.11 | 77.73 | 45.2 |
| liquid (before | | | | | | | | |
| processing) | | | | | | | | |
| ZBY atomization | 0.09 | 0.281 | 0.653 | ND | 20.45 | ND | ND | 17.96 |
| liquid (after | | | | | | | | |
| processing) | | | | | | | | |
| DFY atomization | 4.31 | 6.93 | 2.83 | 0.386 | 2887.67 | 184.38 | 208.99 | 51.19 |
| liquid (before | | | | | | | | |
| processing) | | | | | | | | |
| DFY atomization | 0.657 | 4.592 | 1.409 | ND | 85.55 | 39.6 | 3.9 | 12.9 |
| liquid (after | | | | | | | | |
| processing) | | | | | | | | |
| NB2 atomization | ND | ND | ND | ND | 919.75 | 67.23 | 11.18 | 14.75 |
| liquid (before | | | | | | | | |
| processing) | | | | | | | | |
| NB2 atomization | ND | ND | ND | ND | 2.5 | ND | ND | 8.21 |
| liquid (after | | | | | | | | |
| processing) | | | | | | | | |

TABLE 4
Anion concentration in the atomization liquid before processing and in
the atomization liquid after processing according to Embodiments 2 to 4

| | Inorganic anion concentration (mg/kg) | | | | | | |
|---|---|---|---|---|---|---|---|
| | Ion type | | | | | | |
| | Fluorine | Chloride | Nitrite ion | Bromine | Nitrate | Sulfate | Phosphate |
| | ion F⁻ | ion Cl⁻ | NO²⁻ | ion Br⁻ | NO³⁻ | ion SO₄²⁻ | ion PO₄³⁻ |
| ZBY atomization | 52.3 | 1878.4 | ND | ND | 1219.2 | ND | 41.3 |
| liquid (before | | | | | | | |
| processing) | | | | | | | |
| ZBY atomization | 27.2 | 31.7 | ND | ND | ND | ND | ND |
| liquid (after | | | | | | | |
| processing) | | | | | | | |
| DFY atomization | 16.7 | 798.4 | 52.6 | ND | 663.1 | ND | 347.1 |
| liquid (before | | | | | | | |
| processing) | | | | | | | |
| DFY atomization | 2.32 | 11.6 | 1.38 | ND | ND | ND | ND |
| liquid (after | | | | | | | |
| processing) | | | | | | | |
| NB2 atomization | ND | 2213.1 | ND | ND | 999.13 | 231.1 | ND |
| liquid (before | | | | | | | |
| processing) | | | | | | | |
| NB2 atomization | ND | ND | ND | ND | ND | ND | ND |
| liquid (after | | | | | | | |
| processing) | | | | | | | |

TABLE 5
Organic base concentration in the atomization liquid before processing and
in the atomization liquid after processing according to Embodiments 2 to 4

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| ZBY | 9.26 | 33.33 | 5.06 | 41.23 | 67.28 | 8.3 |
| atomization | | | | | | |
| liquid (before | | | | | | |
| processing) | | | | | | |
| ZBY | 1.25 | 1.99 | 0.09 | 6.86 | 7.97 | 5.54 |
| atomization | | | | | | |
| liquid (after | | | | | | |
| processing) | | | | | | |
| DFY | 10.88 | 27.03 | 4.62 | 36.67 | 69.97 | 13.06 |
| atomization | | | | | | |
| liquid (before | | | | | | |
| processing) | | | | | | |
| DFY | 3.83 | 11.09 | 0.48 | 17.19 | 27.31 | 10.66 |
| atomization | | | | | | |
| liquid (after | | | | | | |
| processing) | | | | | | |
| NB2 atomization | 10.54 | 19.42 | 2.64 | 31.35 | 175.9 | 12.96 |
| liquid (before | | | | | | |
| processing) | | | | | | |
| NB2 atomization | 2.66 | 3.77 | 0.10 | 9.08 | 17.8 | 9.96 |
| liquid (after | | | | | | |
| processing) | | | | | | |

TABLE 6
Organic acid concentration in the atomization liquid before processing and
in the atomization liquid after processing according to Embodiments 2 to 4

| | Organic acid concentration | | | |
|---|---|---|---|---|
| | Tartaric | Acetic | Propionic | 2-methylbutyric |
| Organic acid type | acid | acid | acid | acid |
| ZBY atomization | 67.7 mg/g | 262 μg/g | 4.83 μg/g | 4.24 μg/g |
| liquid | | | | |
| (before processing) | | | | |
| ZBY atomization | ND | 153 μg/g | 3.91 μg/g | 3.27 μg/g |
| liquid | | | | |
| (after processing) | | | | |
| DFY atomization | 219 mg/g | 417 μg/g | 12.23 μg/g | 3.22 μg/g |
| liquid | | | | |
| (before processing) | | | | |
| DFY atomization | ND | 103 μg/g | ND | ND |
| liquid | | | | |
| (after processing) | | | | |
| NB2 atomization | 51.9 mg/g | 210 μg/g | ND | ND |
| liquid | | | | |
| (before processing) | | | | |
| NB2 atomization | ND | 65.6 μg/g | ND | ND |
| liquid | | | | |
| (after processing) | | | | |

The pH of the ZBY atomization liquid before processing is 5.23, and the pH of the ZBY atomization liquid after processing according to Embodiment 2 is 5.16. It can be learned from Table 3 to Table 6 that after electrodialysis processing, not only the concentration of inorganic cations and inorganic anions in the atomization liquid decreases significantly, but also the concentration of organic acids and organic bases in the atomization liquid decreases significantly.

TABLE 7
Concentration of cations and anions in the ZBY atomization liquid before processing
and in the ZBY atomization liquid after processing according to Embodiment 5
Concentration of inorganic cations in the ZBY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 2.31 | 2.32 | 4.24 | 0.123 | 3971.45 | 151.11 | 77.73 | 45.2 |
| processing | | | | | | | | |
| After | ND | ND | ND | ND | 91.34 | 32.02 | 11.31 | 2.36 |
| processing | | | | | | | | |

| Concentration of inorganic anions in the ZBY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 52.3 | 1878.4 | ND | ND | 1219.2 | ND | 41.3 |
| processing | | | | | | | |
| After | 19.34 | 21.33 | ND | ND | 31.64 | ND | ND |
| processing | | | | | | | |

TABLE 8
Concentration of organic bases in the ZBY atomization liquid before processing
and in the ZBY atomization liquid after processing according to Embodiment 5

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| ZBY atomization | 9.26 | 33.33 | 5.06 | 41.23 | 67.28 | 8.3 |
| liquid (before | | | | | | |
| processing) | | | | | | |
| ZBY atomization | 4.31 | 15.96 | 3.66 | 18.34 | 11.69 | 2.22 |
| liquid (after | | | | | | |
| processing) | | | | | | |

TABLE 9
Concentration of organic acids in the ZBY atomization
liquid before processing and in the ZBY atomization
liquid after processing according to Embodiment 5

| | Tartaric | Acetic | Propionic | 2-methylbutyric |
|---|---|---|---|---|
| Organic acid type | acid | acid | acid | acid |
| ZBY atomization liquid | 67.7 mg/g | 262 μg/g | 4.83 μg/g | 4.24 μg/g |
| (before processing) | | | | |
| ZBY atomization liquid | ND | 113 μg/g | ND μg/g | 3.98 μg/g |
| (after processing) | | | | |

TABLE 10
Concentration of cations and anions in the ZBY atomization liquid before processing
and in the ZBY atomization liquid after processing according to Embodiment 6
Concentration of inorganic cations in the ZBY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 2.31 | 2.32 | 4.24 | 0.123 | 3971.45 | 151.11 | 77.73 | 45.2 |
| processing | | | | | | | | |
| After | 2.11 | 1.94 | 3.36 | ND | 963.46 | 99.33 | 38.94 | 20.31 |
| processing | | | | | | | | |

| Concentration of inorganic anions in the ZBY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 52.3 | 1878.4 | ND | ND | 1219.2 | ND | 41.3 |
| processing | | | | | | | |
| After | 39.64 | 368.84 | ND | ND | 369.31 | ND | 39.6 |
| processing | | | | | | | |

TABLE 11
Concentration of organic bases in the ZBY atomization liquid before processing
and in the ZBY atomization liquid after processing according to Embodiment 6

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| ZBY atomization | 9.26 | 33.33 | 5.06 | 41.23 | 67.28 | 8.3 |
| liquid (before | | | | | | |
| processing) | | | | | | |
| ZBY atomization | 8.36 | 29.16 | 2.33 | 24.19 | 36.95 | 4.44 |
| liquid (after | | | | | | |
| processing) | | | | | | |

TABLE 12
Concentration of organic acids in the ZBY atomization liquid before
processing and in the ZBY atomization liquid after
processing according to Embodiment 6

| Organic | Tartaric | Acetic | Propionic | 2-methylbutyric |
|---|---|---|---|---|
| acid type | acid | acid | acid | acid |
| ZBY | 67.7 mg/g | 262 μg/g | 4.83 μg/g | 4.24 μg/g |
| atomization | | | | |
| liquid | | | | |
| (before | | | | |
| processing) | | | | |
| ZBY | 51 mg/g | 136.41 μg/g | 3.32 μg/g | 2.19 μg/g |
| atomization | | | | |
| liquid | | | | |
| (after | | | | |
| processing) | | | | |

TABLE 13
Concentration of cations and anions in the ZBY atomization liquid before processing
and in the ZBY atomization liquid after processing according to Embodiment 7
Concentration of inorganic cations in the ZBY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 2.31 | 2.32 | 4.24 | 0.123 | 3971.45 | 151.11 | 77.73 | 45.2 |
| processing | | | | | | | | |
| After | ND | ND | ND | ND | 52.15 | 36.94 | ND | ND |
| processing | | | | | | | | |

| Concentration of inorganic anions in the ZBY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 52.3 | 1878.4 | ND | ND | 1219.2 | ND | 41.3 |
| processing | | | | | | | |
| After | ND | 44.98 | ND | ND | 11.31 | ND | ND |
| processing | | | | | | | |

TABLE 14
Concentration of organic bases in the ZBY atomization liquid before processing
and in the ZBY atomization liquid after processing according to Embodiment 7

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| ZBY atomization | 9.26 | 33.33 | 5.06 | 41.23 | 67.28 | 8.3 |
| liquid (before | | | | | | |
| processing) | | | | | | |
| ZBY atomization | 2.64 | 11.36 | ND | 13.66 | 8.94 | 7.36 |
| liquid (after | | | | | | |
| processing) | | | | | | |

TABLE 15
Concentration of organic acids in the ZBY atomization liquid before
processing and in the ZBY atomization liquid
after processing according to Embodiment 7

| | Tartaric | Acetic | Propionic | 2-methylbutyric |
|---|---|---|---|---|
| Organic acid type | acid | acid | acid | acid |
| ZBY atomization liquid | 67.7 mg/g | 262 μg/g | 4.83 μg/g | 4.24 μg/g |
| (before processing) | | | | |
| ZBY atomization liquid | ND | 113 μg/g | 1.94 μg/g | 2.68 μg/g |
| (after processing) | | | | |

TABLE 16
Concentration of cations and anions in the tobacco extract before processing
and in the tobacco extract after processing according to Embodiment 8
Concentration of inorganic cations in the tobacco extract BL (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 9.64 | ND | ND | ND | 9761.31 | 1643.61 | 365.13 | 91.11 |
| processing | | | | | | | | |
| After | ND | ND | ND | ND | 23.66 | 16.31 | ND | ND |
| processing | | | | | | | | |

| Concentration of inorganic anions in the tobacco extract BL (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 52.3 | 1878.4 | ND | ND | 1219.2 | ND | 41.3 |
| processing | | | | | | | |
| After | ND | 44.98 | ND | ND | 11.31 | ND | ND |
| processing | | | | | | | |

TABLE 17
Concentration of organic bases in the tobacco extract before processing
and in the tobacco extract after processing according to Embodiment 8

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| Tobacco extract BL | 69.3 | 98.9 | 148.9 | 329.4 | 490.2 | 382.3 |
| (before processing) | | | | | | |
| Tobacco extract BL | 29.9 | 19.24 | 21.9 | 8.33 | 49.2 | 11.7 |
| (after processing) | | | | | | |

TABLE 18
Concentration of organic acids in the tobacco extract before processing
and in the tobacco extract after processing according to Embodiment 8

| | Tartaric | Acetic | Propionic | 2-methylbutyric |
|---|---|---|---|---|
| Organic acid type | acid | acid | acid | acid |
| Tobacco extract BL | 104.3 mg/g | 493.2 μg/g | ND | 21.23 μg/g |
| (before processing) | | | | |
| Tobacco extract BL | 11.3 mg/g | 149.2 μg/g | ND | 4.92 μg/g |
| (after processing) | | | | |

It can be learned from Table 16 to Table 18 that after processing, the concentration of cations, anions, organic bases, and organic acids in the tobacco extract decreases significantly, that is, the method in the present invention may also be used to process the tobacco extract.

TABLE 19
Concentration of cations and anions in the XLY atomization liquid before processing
and in the XLY atomization liquid after processing according to Embodiment 9
Concentration of inorganic cations in the XLY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 1.12 | 3.24 | 3.43 | ND | 13546 | 346 | 634 | ND |
| processing | | | | | | | | |
| After | ND | ND | 1.34 | ND | 64.31 | 21.32 | 11.64 | ND |
| processing | | | | | | | | |

| Concentration of inorganic anions in the XLY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 55.6 | 5757.5 | ND | ND | 7278.2 | ND | ND |
| processing | | | | | | | |
| After | 54.16 | 541.64 | ND | ND | 7000.64 | ND | ND |
| processing | | | | | | | |

TABLE 20
Concentration of cations and anions in the XLY atomization liquid before processing
and in the XLY atomization liquid after processing according to Embodiment 10
Concentration of inorganic cations in the XLY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 1.12 | 3.24 | 3.43 | ND | 13546 | 346 | 634 | ND |
| processing | | | | | | | | |
| After | ND | ND | 1.34 | ND | 13.16 | 19.84 | ND | ND |
| processing | | | | | | | | |

| Concentration of inorganic anions in the XLY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 55.6 | 5757.5 | ND | ND | 7278.2 | ND | ND |
| processing | | | | | | | |
| After | ND | 121.64 | ND | ND | ND | ND | ND |
| processing | | | | | | | |

TABLE 21
Concentration of cations and anions in the XLY atomization liquid before processing
and in the XLY atomization liquid after processing according to Embodiment 11
Concentration of inorganic cations in the XLY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 1.12 | 3.24 | 3.43 | ND | 13546 | 346 | 634 | ND |
| processing | | | | | | | | |
| After | ND | ND | 2.46 | ND | 423.16 | 114.84 | 163.47 | ND |
| processing | | | | | | | | |

| Concentration of inorganic anions in the XLY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 55.6 | 5757.5 | ND | ND | 7278.2 | ND | ND |
| processing | | | | | | | |
| After | 16.97 | 463.14 | ND | ND | 1302.1 | ND | ND |
| processing | | | | | | | |

TABLE 22
Concentration of cations and anions in the ZBY atomization liquid before processing
and in the ZBY atomization liquid after processing according to Embodiment 12
Concentration of inorganic cations in the ZBY atomization liquid (mg/kg)

| | Ion type | | | | | | | |
|---|---|---|---|---|---|---|---|---|
| | Manganese | Iron | Zinc | Copper | Potassium | Magnesium | Calcium | Sodium |
| | ion | ion | ion | ion | ion | ion | ion | ion |
| Before | 2.31 | 2.32 | 4.24 | 0.123 | 3971.45 | 151.11 | 77.73 | 45.2 |
| processing | | | | | | | | |
| After | ND | ND | ND | ND | 31.49 | 16.97 | 6.99 | ND |
| processing | | | | | | | | |

| Concentration of inorganic anions in the ZBY atomization liquid (mg/kg) | |
|---|---|
| | Ion type |

| | Fluorine | Chloride | Nitrite | Bromine | Nitrate | Sulfate | Phosphate |
|---|---|---|---|---|---|---|---|
| | ion F⁻ | ion Cl⁻ | ion NO²⁻ | ion Br⁻ | ion NO³⁻ | ion SO₄²⁻ | ion PO₄³⁻ |
| Before | 52.3 | 1878.4 | ND | ND | 1219.2 | ND | 41.3 |
| processing | | | | | | | |
| After | 16.98 | 43.06 | ND | ND | 18.94 | ND | ND |
| processing | | | | | | | |

TABLE 23
Concentration of organic bases in the ZBY atomization liquid before processing
and in the ZBY atomization liquid after processing according to Embodiment 12

| | Concentration of organic bases (μg/g) | | | | | |
|---|---|---|---|---|---|---|
| | Organic base type | | | | | |
| | 2,3- | Equisetum | | | | |
| | bipyridine | alkaloid | Myosmine | Anatabine | Nornicotine | Cotinine |
| ZBY atomization | 9.26 | 33.33 | 5.06 | 41.23 | 67.28 | 8.3 |
| liquid (before | | | | | | |
| processing) | | | | | | |
| ZBY atomization | ND | 2.97 | ND | 4.16 | 11.16 | 3.97 |
| liquid (after | | | | | | |
| processing) | | | | | | |

TABLE 24
Concentration of organic acids in the ZBY atomization liquid before
processing and in the ZBY atomization liquid after
processing according to Embodiment 12

| | Tartaric | Acetic | Propionic | 2-methylbutyric |
|---|---|---|---|---|
| Organic acid type | acid | acid | acid | acid |
| ZBY atomization | 67.7 mg/g | 262 μg/g | 4.83 μg/g | 4.24 μg/g |
| liquid | | | | |
| (before processing) | | | | |
| ZBY atomization | 38.09 mg/g | 94.94 μg/g | 3.91 μg/g | 3.27 μg/g |
| liquid | | | | |
| (after processing) | | | | |

### Test Example 3

### Test of Atomization Amount and Attenuation Rate

Separately load the above atomization liquid into an atomizer with a battery of 6.5 W power, inhale 1200 puffs, and test the atomization amount (mg/puff) and the vapor attenuation rate (%) (atomization amount: average mass of atomized aerosol per puff of an electronic atomization device attenuation rate: attenuation of the average atomization amount of the first 50 puffs of the electronic atomization device compared with the average atomization amount of the last 50 puffs). The atomization amounts and the vapor attenuation rates of the atomization liquid before processing and the atomization liquid after processing according to Embodiments 1-7 and Embodiments 9-12 are shown in Tables 25-29 and Tables 31-34. The atomization amounts and the vapor attenuation rates of the atomization liquid including the tobacco extract before processing and the atomization liquid including the tobacco extract after processing according to Embodiment 8 are shown in Table 30.

TABLE 25
Atomization amounts and vapor attenuation rates of the XLY atomization
liquid before processing and the XLY atomization
liquid after processing according to Embodiment 1

| XLY atomization | Atomization | Vapor attenuation |
|---|---|---|
| liquid | amount (mg/puff) | rate (%) |
| Before processing | 6.74 | 18.91% |
| After processing | 7.14 | 7.84% |

As shown in Table 25, the ion exchange method has no significant impact on the atomization amount. The vapor attenuation rate decreases from 18.91% to 7.84% and is reduced by about 60%.

TABLE 26
Atomization amounts and vapor attenuation rates of the ZBY
atomization liquid, the DFY atomization liquid, and the
NB2 atomization liquid before processing and the ZBY
atomization liquid, the DFY atomization liquid, and the
NB2 atomization liquid after processing according to Embodiments 2 to 4

| | Atomization | Vapor |
|---|---|---|
| | amount | attenuation |
| Atomization liquid | (mg/puff) | rate (%) |
| ZBY atomization liquid (before processing) | 6.35 | 22.10% |
| ZBY atomization liquid (after processing) | 8.64 | 6.88% |
| DFY atomization liquid (before processing) | 6.98 | 18.90% |
| DFY atomization liquid (after processing) | 8.96 | 5.66% |
| NB2 atomization liquid (before processing) | 7.12 | 16.40% |
| NB2 atomization liquid (after processing) | 9.23 | 4.98% |

As shown in Table 26, the electrodialysis method not only increases the atomization amount by about 30%, but also reduces the vapor attenuation rate by about 70%.

TABLE 27
Atomization amounts and vapor attenuation rates of the ZBY atomization
liquid before processing and the ZBY atomization
liquid after processing according to Embodiment 5

| ZBY atomization | Atomization amount | Vapor attenuation |
|---|---|---|
| liquid | (mg/puff) | rate (%) |
| Before processing | 6.35 | 22.10% |
| After processing | 7.36 | 9.68% |

TABLE 28
Atomization amounts and vapor attenuation rates of the ZBY
atomization liquid before processing and the ZBY atomization
liquid after processing according to Embodiment 6

| ZBY atomization | Atomization | Vapor attenuation |
|---|---|---|
| liquid | amount (mg/puff) | rate (%) |
| Before processing | 6.35 | 22.10% |
| After processing | 6.66 | 19.63% |

It can be learned from Tables 27 and 28 that adjusting the parameters (voltage, current, and circulation time) at electrodialysis can still improve the atomization amount and the vapor attenuation rate of the ZBY atomization liquid.

TABLE 29
Atomization amounts and vapor attenuation rates of the ZBY atomization
liquid before processing and the ZBY atomization liquid
after processing according to Embodiment 7

| ZBY atomization | Atomization amount | Vapor attenuation |
|---|---|---|
| liquid | (mg/puff) | rate (%) |
| Before processing | 6.35 | 22.10% |
| After processing | 7.98 | 10.66% |

TABLE 30
Atomization amounts and vapor attenuation rates of the atomization
liquid added with an unprocessed tobacco extract and the atomization
liquid added with a tobacco extract processed according to Embodiment 8

| Atomization liquid added | Atomization | Vapor |
|---|---|---|
| with 1 wt % | amount | attenuation rate |
| tobacco extract (BL) | (mg/puff) | (%) |
| Unprocessed | 4.91 | 29.40% |
| Processed | 6.66 | 7.31% |

It can be learned from Table 30 that, compared with the atomization liquid added with the 1 wt % unprocessed tobacco extract, the atomization amount of the atomization liquid added with 1 wt % processed tobacco extract increases by about 35% and the vapor attenuation rate decreases by about 75%.

TABLE 31
pH, atomization amounts, and vapor attenuation rates of the XLY
atomization liquid before processing and the XLY atomization
liquid after processing according to Embodiment 9

| XLY atomization | | Atomization amount | Vapor attenuation rate |
|---|---|---|---|
| liquid | pH | (mg/puff) | (%) |
| Before processing | 5.23 | 6.74 | 18.91% |
| After processing | 2.11 | 6.98 | 13.41% |

TABLE 32
pH, atomization amounts, and vapor attenuation rates of the XLY
atomization liquid before processing and the XLY atomization
liquid after processing according to Embodiment 10

| XLY atomization | | Atomization amount | Vapor attenuation rate |
|---|---|---|---|
| liquid | pH | (mg/puff) | (%) |
| Before processing | 5.23 | 6.74 | 18.91% |
| After processing | 3.94 | 7.68 | 9.41% |

TABLE 33
pH, atomization amounts, and vapor attenuation rates of the
XLY atomization liquid before processing and the XLY atomization
liquid after processing according to Embodiment 11

| XLY atomization | | Atomization amount | Vapor attenuation rate |
|---|---|---|---|
| liquid | pH | (mg/puff) | (%) |
| Before processing | 5.23 | 6.74 | 18.91% |
| After processing | 4.14 | 6.88 | 14.32% |

TABLE 34
Atomization amounts and vapor attenuation rates of the ZBY atomization
liquid before processing and the ZBY atomization liquid
after processing according to Embodiment 12

| ZBY atomization | Atomization amount | Vapor attenuation |
|---|---|---|
| liquid | (mg/puff) | rate (%) |
| Before processing | 6.35 | 22.10% |
| After processing | 8.21 | 8.39% |

With reference to Table 26, compared with the ZBY atomization liquid processed by using the ion exchange method in Embodiment 12, the ZBY atomization liquid processed by using the electrodialysis method in Embodiment 2 has a larger atomization amount and a higher improvement degree of the vapor attenuation rate.

### Test Example 4

### Test of Fouling

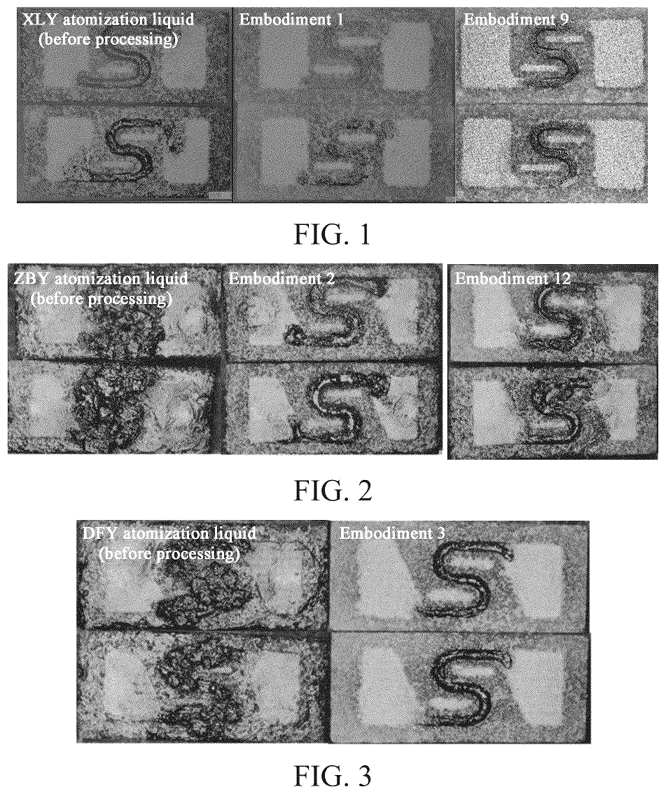

Separately load the XLY atomization liquid before processing and the XLY atomization liquid after processing according to Embodiment 1 and Embodiment 9 into the atomizer with a battery of 6. 5W power, inhale 1200 puffs, take out the atomization core, cut off and photograph the atomization core. Results are shown in FIG. 1. It can be learned from FIG. 1 that, compared with the XLY atomization liquid before processing, the fouling of the XLY atomization liquid processed by using the cation exchange resin according to Embodiment 9 decreases in the electronic atomization device. Compared with the XLY atomization liquid processed by only using the cation exchange resin in Embodiment 9, the XLY atomization liquid processed by using the cation exchange resin and the anion exchange resin in Embodiment 1 decreases more in fouling in the electronic atomization device.

Separately load the ZBY atomization liquid before processing and the ZBY atomization liquid after processing according to Embodiment 2 and Embodiment 12 into the atomizer with a battery of 6.5 W power, both inhale 1600 puffs, separately take out the atomization core, cut off and photograph the atomization core. Results are shown in FIG. 2. It can be learned from FIG. 2 that, compared with the ZBY atomization liquid before processing, the ZBY atomization liquid processed by using the ion exchange method according to Embodiment 12 has less fouling in the atomization apparatus. However, compared with the ZBY atomization liquid processed by using the ion exchange method according to Embodiment 12, the ZBY atomization liquid processed by using the electrodialysis method according to Embodiment 2 decreases more in fouling in the electronic atomization device.

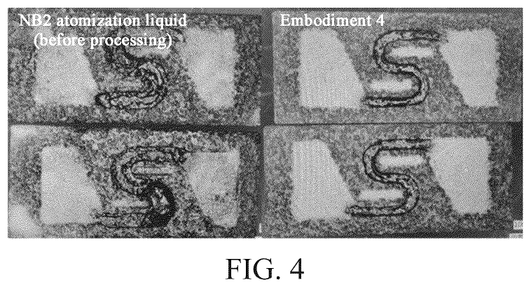

Separately load the DFY atomization liquid before processing and the DFY atomization liquid after processing according to Embodiment 3 into the atomizer with a battery of 6.5 W power, both inhale 1600 puffs, separately take out the atomization core, cut off and photograph the atomization core. Results are shown in FIG. 3. Separately load the NB2 atomization liquid before processing and the NB2 atomization liquid after processing according to Embodiment 4 into the atomizer with a battery of 6.5 W power, both inhale 1200 puffs, separately take out the atomization core, cut off and photograph the atomization core. Results are shown in FIG. 4. It can be learned from FIG. 2, FIG. 3, and FIG. 4 that, for all the atomization liquids with different fouling amounts in the electronic atomization device, electrodialysis processing can significantly reduce the fouling.

### Test Example 5

### Test of Sensory Inhalation

The sensory inhalation results, by 20 people, of the ZBY atomization liquid, the DFY atomization liquid, and the NB2 atomization liquid before processing, and the ZBY atomization liquid, the DFY atomization liquid, and the NB2 atomization liquid after processing according to Embodiments 2-4 are described as follows: 19 people believe that the ZBY atomization liquid processed according to Embodiment 2 is not different from the ZBY atomization liquid before processing. 18 people believe that the DFY atomization liquid processed according to Embodiment 3 is not different from the DFY atomization liquid before processing. 19 people believe that the NB2 atomization liquid processed according to Embodiment 4 is not different from the NB2 atomization liquid before processing.

The same 20 people inhale the ZBY atomization liquid before processing and the ZBY atomization liquid after processing according to Embodiment 12, and the results are described as follows: Compared with the ZBY atomization liquid before processing, 11 people believe that the ZBY atomization liquid after processing according to Embodiment 12 is not different, and 9 people believe that the ZBY atomization liquid after processing according to Embodiment 12 is softer and sourer.

It can be learned from the foregoing inhalation results that, compared with the ZBY atomization liquid processed by using the ion exchange method in Embodiment 12, the mouthfeel of the ZBY atomization liquid processed by using the electrodialysis method in Embodiment 2basically does not change. That is, the electrodialysis method can maintain the mouthfeel of the atomization liquid, which may be related to that the pH of the system does not change significantly.

In conclusion, the method for preparing an additive liquid of an atomizer in the present invention can help to implement long-term inhalation experience of a large vapor quantity and a large quantity of puffs, and can also avoid the problem of burnt coil or gunk buildup in the electronic atomization device during the service life.

The foregoing descriptions are merely exemplary embodiments of the present invention, and are not intended to limit the protection scope of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for preparing an additive liquid of an atomizer, comprising:
removing cations.

2. The method of claim 1, further comprising:
removing anions to obtain a liquid with an electrical conductivity less than 1000 μS/cm.

3. The method of claim 1, wherein the cations are selected from a group comprising: manganese ions, iron ions, zinc ions, copper ions, potassium ions, magnesium ions, calcium ions, and sodium ions.

4. The method of claim 2, wherein removing cations is performed using a cation exchange resin, and
wherein removing anions is performed using an anionic exchange resin.

5. The method of claim 2, wherein the removing cations and the removing anions are simultaneously performed through electrodialysis.

6. The method of claim 5, wherein a voltage during the electrodialysis is 1 V to 30 V,
wherein a current during the electrodialysis is 0.05 A to 20 A, and
wherein a duration of the electrodialysis is 0.1 hour to 24 hours.

7. The method of claim 1, further comprising:
adding an atomization solvent and/or an essence.

8. The method of claim 1, wherein before removing cations, the method further comprises diluting a to-be-processed substance with water to obtain a diluted liquid with a viscosity of 1 cp to 100 cp, and
wherein after removing cations, the method further comprises removing water.

9. An additive liquid of an atomizer prepared using the method of claim 1.

10. An atomizer, comprising:
a liquid storage chamber configured to accommodate an additive liquid of the atomizer;
an atomization component configured to cause the additive liquid of the atomizer to form an aerosol, the atomization component being in fluid communication with the liquid storage chamber; and
the additive liquid of the atomizer of claim 9.

11. The method of claim 2, wherein the electrical conductivity is less than 500 μS/cm.

12. The method of claim 6, wherein the voltage during the electrodialysis is 12 V to 16 V,
wherein the current during the electrodialysis is 5 A to 10 A, and
wherein the duration of the electrodialysis is 1 hour to 4 hours.

13. The method of claim 8, wherein the diluting is performed by adding water with a volume greater than 0 times and less than or equal to 20 times a volume of the to-be-processed substance.
